(19) United States
(12) Patent Application Publication
(10) Pub. No.: US 2013/0126091 A1
(43) Pub. Date: May 23, 2013

(54) ADHESIVE FOR FIXING AND/OR EMBEDDING AN ELECTRONIC COMPONENT AND METHOD AND USE

(71) Applicants: Wolfgang Schrittwieser, Kapfenberg (AT); Patrick Lenhardt, Spielberg (AT); Patrick Grasser, Spielberg (AT)

(72) Inventors: Wolfgang Schrittwieser, Kapfenberg (AT); Patrick Lenhardt, Spielberg (AT); Patrick Grasser, Spielberg (AT)

(73) Assignee: AT & S Austria Technologie & Systemtechnik Aktiengesellschaft, Leoben-Hinterberg (AT)

(21) Appl. No.: 13/813,507

(22) PCT Filed: Aug. 2, 2011
(86) PCT No.: PCT/AT2011/000321

§ 371 Date: Jan. 31, 2013

(30) Foreign Application Priority Data
Aug. 4, 2010 (EP) 10450127.5

(51) Int. Cl. C09J 163/00

(52) U.S. Cl. CPC C09J 163/00
USPC 156/332; 523/400; 523/455

(57) ABSTRACT

In the case of an adhesive for fixing an electronic component on a circuit board and/or for embedding an electronic component into a circuit board, the electronic component to be fixed and/or embedded being fixed by means of an adhesive bond on a ply or layer of a circuit board, and fixing optionally being followed by jacketing by plies, and/or by covering by at least one further ply, an epoxy resin-based adhesive is selected, which has at least one added additive to adjust the surface tension and/or viscosity, especially a defoamer and/or an additive for adjusting the levelling properties, which can achieve reliable fixing of a component, especially with avoidance of cavities or air inclusions below the surface of the component to be fixed. Also provided are a method and a use.

This is a national stage of PCT/AT2011/000321 filed Aug. 2, 2011 and published in German, which has a priority of a European Patent Application no. 10450127.5 filed Aug. 4, 2010, hereby incorporated by reference.

### FIELD OF THE INVENTION

The present invention relates to an adhesive for fixing an electronic component to a circuit board and/or embedding an electronic component into a circuit board, the electronic component to be fixed and/or embedded being fixed by means of an adhesive bond to a ply or layer of a circuit board, in particular a multilayer circuit board, and after fixing being optionally encapsulated, in particular by layers matched to the outer contours of the component to be embedded, and/or covered by at least one further layer. The present invention, furthermore, relates to a method for fixing an electronic component to a circuit board and/or embedding an electronic component into a circuit board, wherein the electronic component to be fixed and/or embedded is fixed by means of an adhesive bond to a layer or ply of a circuit board, in particular a multilayer circuit board, and after fixing is optionally encapsulated by layers particularly matched to the outer contours of the component to be embedded, and/or covered by at least one further layer using such an adhesive. The present invention, moreover, relates to the use of such a method and such an adhesive.

### PRIOR ART

In the context of fixing an electronic component to or on a circuit board, and/or for embedding an electronic component into a circuit board, the problem frequently occurs that an adhesive applied, for instance, by a printing process to a layer or ply of an, in particular multilayer, circuit board, after the arrangement or positioning of a component to be fixed or embedded forms an air-filled cavity below the component to be fixed or embedded, which cavity will remain even after the subsequent solidification of the adhesive. Such an air-filled or gas-filled cavity below the, for instance substantially plane, surface of the component is, in particular, caused by the shape of the adhesive after its application to the layer or ply, which resembles a crater or has an accordingly enlarged height in peripheral regions of the application surface. In the context of further processing a circuit board provided with such a component, at least partially elevated temperatures are applied, the air-filled cavity present below the component under such high temperatures possibly leading to tensions in the region of the fixation of the component to the circuit board or even to the destruction of the adhesive bond, and hence to the lifting or detachment of the component, or, in the worst case, to the destruction of the component proper. For subsequent contacting steps, it must, moreover, for instance, be safeguarded that the adhesive layer provided between the component and the layer or ply of the circuit board is uniformly and consistently provided below the entire surface of the component in order to enable the defined arrangement of contact sites, for instance when forming holes or passages for contacting, which, as a rule, will subsequently be filled with a conducting material to ensure proper contacting.

### SUMMARY OF THE INVENTION

The present invention, therefore, aims to further develop an adhesive and a method of the initially-defined kind to the effect that the problems of the above-mentioned prior art will be avoided and it will, in particular, be ensured that the adhesive will be uniformly applied between the layer or ply of the circuit board and the surface of the component to be fixed or embedded while avoiding the formation of an air-filled cavity below the component to be fixed or embedded.

To solve the above-identified objects, an adhesive of the initially-defined kind is substantially characterized in that an epoxy resin-based adhesive is selected, which comprises at least one additive added for adjusting the surface tension and/or viscosity, in particular a defoamer and/or an additive for adjusting the levelling properties. By providing an epoxy resin-based adhesive, the properties of the adhesive bond between the electronic component and the circuit board, that are required for reliable adherence will be ensured, wherein the surface tension and/or viscosity of such an epoxy resin-based adhesive, that are required to achieve a convex surface will be attainable by additives.

In order to adjust the required surface tension and/or viscosity, it is proposed according to a preferred embodiment that a defoamer, for instance a silicone-free defoamer, is added to the adhesive in an amount of less than 3% by weight and, in particular, about 0.1 to 2.0% by weight. By adding a defoamer in the indicated amount, the desired properties in respect to the formation of a convex surface will be achieved, particularly while preserving the adhesive properties of the adhesive.

In order to adjust the desired levelling properties to achieve the convex surface, it is, moreover, proposed that an acrylate, e.g. poly(butyl acrylate), an acrylate copolymer, e.g. methacrylate copolymer, an epoxy resin comprising free hydroxyl, isocyanate and/or ester groups, or the like, is added as an additive for improving the levelling properties, as in correspondence with a further preferred embodiment of the adhesive according to the invention. In this context, it is proposed according to a further preferred embodiment that an additive for improving the levelling properties is added in an amount of at most 7% by weight and, in particular, 0.5 to 5% by weight.

In particular, for adaptation to different purposes of use and/or for adaptation to different subsequent processing or treatment steps, it is preferably proposed according to the invention that a plurality of different additives for improving the levelling properties is added.

The convex surface of the adhesive to be provided by the invention is, in particular, influenced by the surface tension of the latter, wherein it is proposed in this connection that the adhesive has a surface tension of less than 40 mN/m and, in particular, between 15 and 35 mN/m, as in correspondence with a preferred embodiment of the adhesive.

Likewise for promoting the reliable formation of a convex surface, it is preferably proposed that the adhesive has a higher viscosity compared to its elasticity at room temperature.

In order to achieve, and maintain, the uniform and consistent adhesive layer between the circuit board and the surface of the component to be embedded or fixed, it is proposed according to a further preferred embodiment that the adhesive at room temperature has a complex viscosity below 50 Pa.s and, in particular, between about 20 and 45 Pa.s. In this context, in order to maintain the properties of the adhesive at elevated temperatures, it is, moreover, proposed that the adhesive comprises a temperature-dependent increase in the complex viscosity during heating from room temperature to about 50° C. within a period of less than 15 min, in particular about 10 min, to, in particular, at least 1.3 times, more particularly about 1.7 to 3 times, the complex viscosity at room temperature.

To solve these objects, a method of the initially-defined kind is, moreover, essentially characterized in that the adhesive used to form the adhesive bond in a manner known per se is applied with a concave surface to the circuit board layer provided for supporting or accommodating the electronic component, that the component to be fixed or embedded is arranged on the adhesive and optionally subjected to compressive stress, and that the adhesive is subjected to a curing treatment after the placement or arrangement of the component. In that it is proposed by the invention to apply with a convex surface to the layer or ply of the circuit board the adhesive used or employed to form the adhesive bond, and to subsequently arrange on the adhesive the component to be fixed or embedded, it will be ensured that the formation of an air-filled cavity below the component to be fixed or embedded will be avoided, since the convex curvature or configuration of the adhesive will safely avoid the formation of cavities when positioning the component on the applied adhesive surface. By providing the convex surface of the adhesive, and hence a substantially maximum thickness in a substantially central region, of the adhesive used for forming the adhesive bond, the uniform and homogenous distribution of the adhesive between the circuit board layer or ply used as a support and the surface of the component to be fixed will thus be ensured, since, in particular during a substantially parallel approach of the respective surface of the component to be fixed or embedded to the adhesive surface disposed on the layer or ply of the circuit board, departing from the substantially central region with the highest elevation of the adhesive surface due to the formation of the convex surface, the complete escape of air in and towards the peripheral regions of the component to be fixed will each occur with the component further approaching said layer or ply. After having positioned the component on the layer or ply via the convex adhesive surface, thus avoiding the formation of cavities below the component to be fixed or embedded, a curing treatment is performed to safely and permanently maintain the uniform and consistent arrangement of the adhesive while avoiding cavities or air inclusions.

In order to prevent adhesive from oozing beyond the contours of the component to be fixed or embedded when providing the convex surface of the adhesive, and hence when placing the adhesive during its distribution, departing from a substantially central partial region comprising the largest thickness of the adhesive, towards the peripheral or edge regions, it is proposed according to a preferred embodiment that the adhesive is applied to the layer for supporting or accommodating the component in a dimension reduced relative to the outer contours of the component to be fixed or embedded. By providing a reduced dimension of the adhesive placed on the layer or ply of the circuit board, a uniform and consistent adhesive surface will thus be safeguarded between the layer or ply of the circuit board and the component via the adhesive bond due to the distribution of the adhesive applied with a convex surface, as the component approaches the layer or ply. At the same time, excessive oozing of adhesive beyond peripheral regions or outer contours of the component to be fixed or embedded will, in particular, be avoided.

In order to achieve the desired uniform distribution of the adhesive while observing the convex surface of the same prior to arranging the component to be fixed or embedded, it is, moreover, proposed that the adhesive is applied with a reduced intensity or thickness and/or in a reduced amount in regions corresponding to peripheral regions of the outer contour of the component to be fixed or embedded, as in correspondence with a further preferred embodiment of the method according to the invention.

In order to prevent excessive agglomerations of adhesive in partial regions, in particular with large-area components, and to ensure the uniform distribution of the adhesive over the entire surface of the component to be fixed or embedded, it is proposed according to a further preferred embodiment that the adhesive, on the layer for supporting the component, is only applied in partial regions as a function of the outer contour of the component to be fixed or embedded, said adhesive being applied with a convex surface in all of the, optionally mutually separated, partial regions. In this manner, a uniform and consistent distribution of the adhesive between the surface of the component to be fixed or embedded and the respective layer or ply of the circuit board will be obtained, in particular in adaptation to the dimensions of the component after the arrangement of the component on the convex adhesive surface.

In order to further assist the uniform and consistent distribution of the adhesive and, in addition, prevent the adhesive from oozing beyond peripheral regions or the outer contours of the component to be embedded or fixed, it is, moreover, proposed that the adhesive, in the case of a substantially rectangular or right-angled component, is applied with a pad-like or cushion-like extension, as in correspondence with a further preferred embodiment of the method according to the invention. Such a pad-like or cushion-like extension providing a convex surface fitting a substantially rectangular or right-angled component, after the arrangement of the component will enable a uniform and consistent distribution avoiding any air inclusions and cavities.

In order to reliably achieve the convex surface, it is proposed according to a further preferred embodiment that the surface tension of the adhesive is selected to be smaller than 40 mN/m and, in particular, between 15 and 35 mN/m. By appropriately selecting or adjusting the surface tension of the adhesive, the convex surface proposed by the invention will be provided when applying the adhesive to the supporting layer or ply of the circuit board so as to avoid air inclusions when fixing the component.

To help assume or provide a convex surface of the adhesive when applying the same, it is proposed according to a further preferred embodiment that an adhesive having a higher viscosity compared to its elasticity at room temperature is selected.

In this context, it is proposed according to a further preferred embodiment that the adhesive at room temperature has a complex viscosity below 50 Pa.s and, in particular, between about 20 and 45 Pa.s. When observing these parameters proposed by the invention for the viscosity of the adhesive at room temperature, the convex surface of the adhesive that is sought for a proper fixation without cavities will be reliably obtained. The complex viscosity is the frequency-dependent viscosity function obtained during a forced harmonic oscillation of a shearing stress.

As already pointed out above, a circuit board and its components are usually exposed to high temperatures and optionally high pressures during further processing steps. In order to ensure the safe adherence, and the uniform and consistent provision, of an adhesive layer below the component while avoiding the formation of cavities even at environmental conditions that have changed relative to those encountered during the arrangement of the component via the adhesive layer particularly at room temperature, it is proposed according to a further preferred embodiment that the adhesive comprises a temperature-dependent increase in the complex viscosity during heating from room temperature to about 50° C. within a period of less than 15 min, in particular about 10 min, to, in particular, at least 1.3 times, more particularly about 1.7 to 3 times, the complex viscosity at room temperature. In this manner, the safe adherence of the component to the circuit board will be enabled even during subsequent processing or treatment steps.

For applying the adhesive with the convex surface proposed by the invention in a particularly simple and reliable manner, it is, moreover, proposed that the adhesive in a manner known per se is applied by a printing process, in particular a screen-printing process, as in correspondence with a further preferred embodiment of the method according to the invention.

To solve the initially-mentioned objects, the use of a method according to the present invention, or a preferred embodiment, and of an adhesive according to the invention, or a preferred embodiment, for fixing an electronic component to or on a circuit board and/or embedding an electronic component into a circuit board are, moreover, proposed by the invention.

### SHORT DESCRIPTION OF THE DRAWINGS

In the following, the invention will be explained in more detail by way of exemplary embodiments schematically illustrated in the accompanying drawing and by examples of compositions of the adhesive according to the invention. In the drawing,

FIG. 1 is a schematic partial view of a circuit board to which a component is fixed using the method and adhesive according to the invention;

FIG. 2 is an idealized schematic illustration of the arrangement of an adhesive according to the invention with a convex surface in the context of the method according to the invention;

FIG. 3 is a likewise idealized illustration of the substantially cushion-like arrangement of an adhesive according to the invention in the context of the method according to the invention for fixing an, in particular rectangular, component; and

FIG. 4 depicts a plurality of schematic illustrations or top views similar to that of FIG. 3, of different configurations of the application or arrangement of an adhesive according to the invention in the context of the method according to the invention.

### DETAILED DESCRIPTION OF PREFERRED EMBODIMENTS

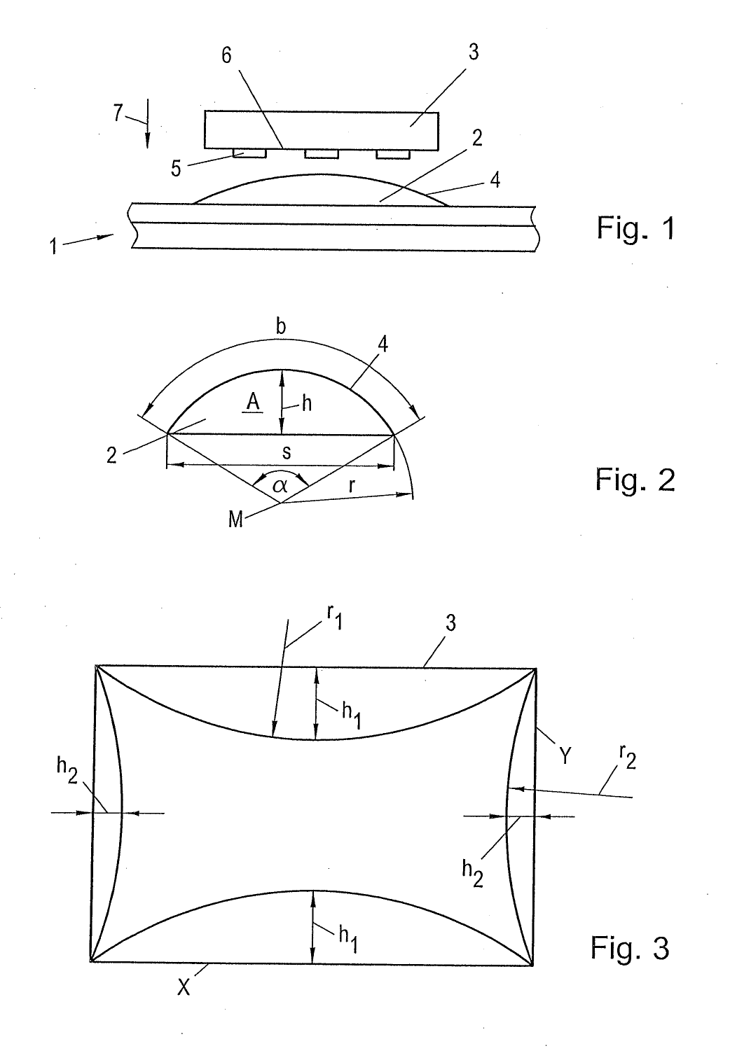

In FIG. 1 a, for instance multilayer, printed circuit board is schematically denoted by 1, to which an electronic component schematically indicated by 3 is to be fixed via an adhesive layer 2. As is schematically indicated in FIG. 1, the adhesive 2, which is used to form the adhesive bond, comprises a convex surface 4 oriented to the component 3 and, in particular, a surface 6 provided, for instance, with contacts 5.

To fix the component 3, the latter is approached, in the sense of arrow 7, to the circuit board 1, to which the adhesive 2 has been applied, for instance, by a printing method, in particular a screen-printing method, whereby full-surface abutment of the surface 4 of the adhesive with the surface 6 of the component 3 to be fixed is, in particular, achieved by the convex surface 4 comprising the largest thickness or extension in the central region of the adhesive 2.

After the arrangement on, or embedment in, the adhesive 2 of the component 3, curing of the adhesive 2 is, for instance, effected.

By providing the convex surface 4 of the adhesive 2, the formation of cavities or air bubbles below the surface 6 of the component 3 to be fixed is avoided such that, in particular in subsequent processing or treatment steps of such a circuit board, a detachment or lifting of the component 3 by an expansion of the gas trapped in a cavity, optionally involving the destruction of the component 3, need not to be feared.

Instead of the fixation of the component 3 to a surface of the circuit board 1, which is schematically illustrated in FIG. 1, the embedding of a component 3 in an appropriate cavity or recess of an, in particular multilayer, circuit board can also be immediately effected. Alternatively to embedding in a cavity, the encapsulation of the component 3 for embedding the same can be performed after the fixation of the component 3 to the circuit board 1 using the adhesive layer 2.

FIG. 2 depicts an idealized illustration of the convex surface 4 of an adhesive layer again denoted by 2.

The geometric relationships in such an idealized case are as follows:

$$b = r \cdot π \cdot \frac{α}{180 °} , \\ h = r - \sqrt{{r}^{2} - {( \frac{s}{2} )}^{2}}$$

$$A = \frac{r \cdot b}{2} - \frac{s \cdot ( r - h )}{2}$$

The chord s in an idealized application corresponds to a length X or a width Y of a substantially rectangular component, whose contours are again denoted by 3 in FIG. 3.

Considering the formulae specified for the formation of the convex surface 4 and the provision of a substantially cushion-like placement of the adhesive 2 on the circuit board layer or ply not illustrated in detail, a uniform and consistent distribution of the adhesive 2 between the supporting layer or ply of the circuit board and the facing surface of the component 3 will be achieved after the arrangement of the component 3 as indicated in FIG. 1. Considering the different dimensions X and Y, different parameters r₁, r₂, h₁, h₂ will result in the above formulae.

From FIG. 3 it is apparent that, due to the cushion-like configuration taking into account the above-identified dimensioning while forming a convex surface as indicated in FIGS. 1 and 2, safe adherence will be achieved over the entire surface of the component 3 defined by length X and width Y.

The cushion-like configuration, in which an adhesive 2 in peripheral or edge regions in substantially central portions along the sides denoted by X and Y is not provided as far as to the edge regions, and the distribution implied by the convex surface during the arrangement of the component 3 on the adhesive surface 2 will, moreover, ensure that no oozing of the adhesive 2 beyond the outer contours of the components 3 will occur. It will thus be avoided that residues of the adhesive protruding beyond the outer contours of the component 3 will, for instance, have to be removed in additional processing steps prior to further processing steps.

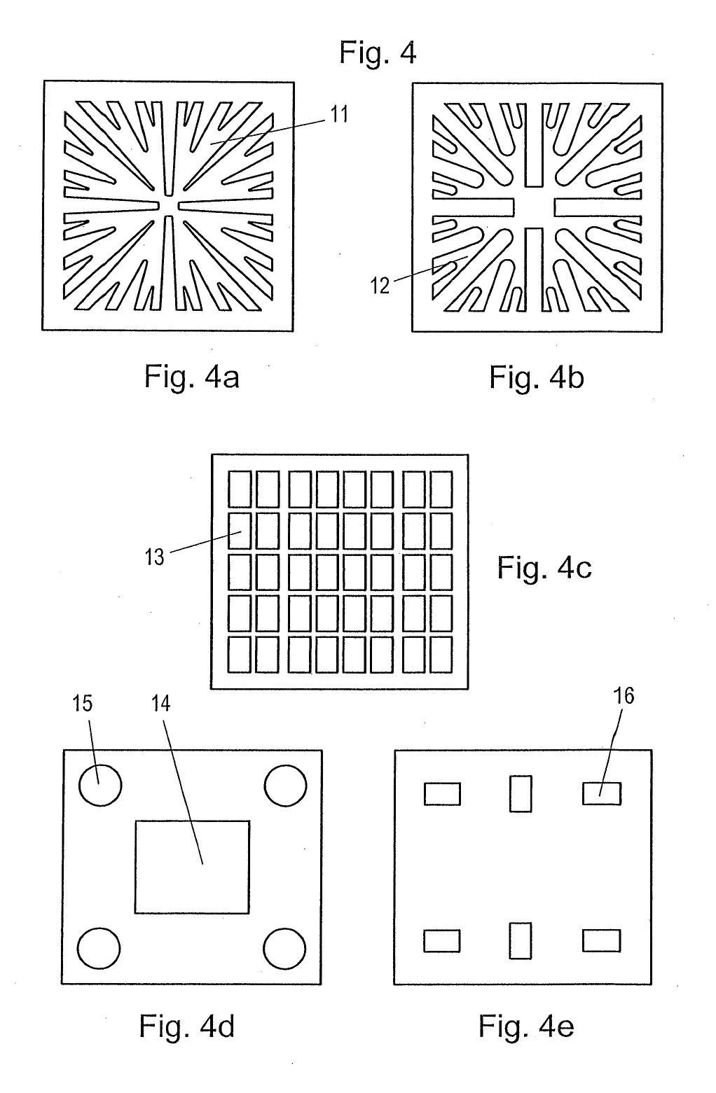

FIG. 4 depicts further modified configurations of the application of an adhesive each schematically for a substantially square component.

Thus, the embodiments according to FIG. 4a and FIG. 4b use substantially star-shaped adhesive arrangements comprising a plurality of partial regions 11 and 12, with free surfaces remaining between the individual partial regions 11 and 12. The individual partial regions 11 and 12 each again have convex surfaces to achieve a uniform distribution of the adhesive during the placement of a component not illustrated in detail.

FIG. 4c depicts a modified embodiment, in which a plurality of individual, substantially rectangular, adhesive surfaces 13 are provided one beside the other according to a matrix taking into account the external dimensions of the component to be fixed, which is not illustrated. The individual partial regions 13 each again comprise a convex surface so as to enable the achievement of a uniform distribution while avoiding the formation of cavities or air inclusions when placing the adhesive through the free surfaces provided between the partial regions 13.

Similar applies to the embodiment illustrated in FIG. 4d, wherein a substantially central region 14 again comprises a convex adhesive surface and substantially circular partial regions 15 are additionally provided in the corner regions.

In the embodiment illustrated in FIG. 4e, small partial regions 16 are substantially provided along side edges, said partial regions again each comprising a convex curvature, and hence enabling a desired fixation with uniform thicknesses each in peripheral regions of a component to be fixed, which is not illustrated in detail.

In order to achieve the desired convex surfaces of the adhesive 2, or of partial regions 11, 12, 13, 14, 15, 16 thereof, as are, in particular, schematically illustrated in FIG. 4, physical data for different exemplary embodiments of adhesives are indicated in Table I below, with a comparative example being additionally shown, yet this would not allow for the formation of a convex surface.

TABLE I

| | | Complex | Complex |
|---|---|---|---|
| | Surface | viscosity | viscosity |
| | tension | 20° C. | 50° C., 10 min. |
| | [mN/m] | [Pa · s] | [Pa · s] |
| Ex. 1 | 30.9 | 22 | 45 |
| Ex. 2 | 31.6 | 33 | 43 |
| Ex. 3 | 31.0 | 43 | 84 |
| Ex. 4 | 32.3 | 23 | 67 |
| Comp. Ex. | 45.4 | 57 | 24 |

From the above Table I, it is apparent that the adhesives according to Examples 1 to 4, which provide convex surfaces, each have a surface tension of approximately 30 mN/M, whereas the surface tension according to the Comparative Example is about 45 N/m.

It is further apparent that the complex viscosity at 20° C. for Examples 1 to 4 is each below 50 Pa.s and, in particular, between 20 and 45 Pa.s, while the respective value for the Comparative Example is beyond a limit of 50 Pa.s.

In addition, it is apparent that the complex viscosity during heating to 50° C. for a period of 10 minutes increases in Examples 1 to 4 forming convex surfaces and, in particular, amounts to at least 1.3 times, preferably 1.7 to 3 times, the complex viscosity at room temperature (20° C.), while the complex viscosity of the Comparative Example decreases to less than half at room temperature.

The complex viscosities both for the Examples mentioned in Table I and the Comparative Example were each determined at constant, standardized oscillation amplitudes and identical angular frequencies of, for instance, 6 (1/s) for both temperatures.

Table II below, moreover, indicates compositions for a plurality of adhesive formulations again providing convex surfaces of the adhesive upon application to a layer or ply of a circuit board, whereas no convex surfaces could be achieved for Comparative Examples.

The adhesive formulations are each based on single-component epoxy resin adhesives having a viscosity of about 20 Pa.s, which is accordingly altered by the addition of the indicated additives.

In the Table below, a silicone-free defoamer, e.g. BYK-054, is used as defoamer.

A polyacrylate, e.g. BYK-S706 or BYK-359, is, for instance, used to improve the levelling properties.

The following indications each refer to percent by weight.

TABLE II

| | | Levelling | |
|---|---|---|---|
| | Solvent % | agent % | Defoamer % |
| Ex. 1 | — | 2 | 0.5 |
| Ex. 2 | — | 2 | 1 |
| Ex. 3 | — | 3 | 1 |
| Ex. 4 | — | 4 | 1 |
| Ex. 5 | 0.3 | 4 | 1 |
| Comp. Ex. 1 | 0.5 | — | 0.7 |
| Comp. Ex. 2 | 0.5 | — | 0.7 |

From Table II above, it is apparent that a convex surface is, in particular, formed when adding a levelling agent and small amounts of a defoamer.

In this respect, the compositions indicated for Examples 1 and 2, which comprise comparatively small amounts of a levelling agent and a defoamer, are particularly suitable for small adhesive surfaces of, for instance, smaller than 2×2 mm.

By increasing the portion of levelling agent, a convex surface will, in particular, be achievable with larger adhesive surfaces. In this respect, a composition according to Example 3 proved to be particularly suitable for adhesive surfaces up to about 6×6 mm, while, according to Examples 4 and 5, convex surfaces up to dimensions of about 10×10 will be achievable.

The compositions according to Examples 4 and 5, moreover, exhibit very good levelling properties. By additionally providing a solvent, defoaming can, moreover, be achieved in containers in Example 5.

By contrast, although a defoaming effect could be obtained in the Comparative Examples, the formation of a convex surface of the adhesive after a printing process, in particular a screen-printing process, could, however, not be achieved, particularly due to the lacking levelling agent, and hence the option to adjust the surface tension as indicated in Table I to an adjustment value of less than 40 mN/m, in particular less than 35 mN/m.

1. An adhesive for fixing an electronic component to a circuit board and/or embedding an electronic component into a circuit board, the electronic component to be fixed and/or embedded being fixed by means of an adhesive bond to a ply or layer of a circuit board, in particular a multilayer circuit board, and after fixing being optionally encapsulated, in particular by layers matched to the outer contours of the component to be embedded, and/or covered by at least one further layer, wherein an epoxy resin-based adhesive is selected, which comprises at least one additive added for adjusting the surface tension and/or viscosity, in particular a defoamer and/or an additive for adjusting the levelling properties.

2. The adhesive according to claim 1, wherein a defoamer, for instance a silicone-free defoamer, is added to the adhesive in an amount of less than 3% by weight and, in particular, about 0.1 to 2.0% by weight.

3. The adhesive according to claim 1, wherein an acrylate, e.g. poly(butyl acrylate), an acrylate copolymer, e.g. methacrylate copolymer, an epoxy resin comprising free hydroxyl, isocyanate and/or ester groups, or the like, is added as an additive for improving the levelling properties.

4. The adhesive according to claim 3, wherein an additive for improving the levelling properties is added in an amount of at most 7% by weight and, in particular, 0.5 to 5% by weight.

5. The adhesive according to claim 3, wherein a plurality of different additives for improving the levelling properties is added.

6. The adhesive according to claim 1, wherein the adhesive has a surface tension of less than 40 mN/m and, in particular, between 15 and 35 mN/m.

7. The adhesive according to claim 1, wherein the adhesive has a higher viscosity compared to its elasticity at room temperature.

8. The adhesive according to claim 1, wherein the adhesive at room temperature has a complex viscosity below 50 Pa.s and, in particular, between about 20 and 45 Pa.s.

9. The adhesive according to claim 1, wherein the adhesive comprises a temperature-dependent increase in the complex viscosity during heating from room temperature to about 50° C. within a period of less than 15 min, in particular about 10 min, to, in particular, at least 1.3 times, more particularly about 1.7 to 3 times, the complex viscosity at room temperature.

10. A method for fixing an electronic component to a circuit board and/or embedding an electronic component into a circuit board, wherein the electronic component to be fixed and/or embedded is fixed by means of an adhesive bond to a layer or ply of a circuit board, in particular a multilayer circuit board, and after fixing is optionally encapsulated by layers particularly matched to the outer contours of the component to be embedded, and/or covered by at least one further layer using an adhesive according to claim 1, wherein the adhesive used to form the adhesive bond in a manner known per se is applied with a concave surface to the circuit board layer provided for supporting or accommodating the electronic component, that the component to be fixed or embedded is arranged on the adhesive and optionally subjected to compressive stress, and that the adhesive is subjected to a curing treatment after the placement or arrangement of the component.

11. The method according to claim 10, wherein the adhesive is applied to the layer for supporting or accommodating the component in a dimension reduced relative to the outer contours of the component to be fixed or embedded.

12. A The method according to claim 10, wherein the adhesive is applied with a reduced intensity or thickness and/or in a reduced amount in regions corresponding to peripheral regions of the outer contour of the component to be fixed or embedded.

13. A The method according to claim 10, wherein the adhesive, on the layer for supporting the component, is only applied in partial as a function of the outer contour of the component to be fixed or embedded, said adhesive being applied with a convex surface in all of the, optionally mutually separated, partial regions.

14. The method according to claim 10, wherein the adhesive, in the case of a substantially rectangular or right-angled component, is applied with a pad-like or cushion-like extension.

15. The method according to claim 10, wherein the surface tension of the adhesive is selected to be smaller than 40 mN/m and, in particular, between 15 and 35 mN/m.

16. The method according to claim 10 wherein an adhesive having a higher viscosity compared to its elasticity at room temperature is selected.

17. The method according to claim 16, wherein the adhesive at room temperature has a complex viscosity below 50 Pa.s and, in particular, between about 20 and 45 Pa.s.

18. The method according to claim 16, wherein the adhesive comprises a temperature-dependent increase in the complex viscosity during heating from room temperature to about 50° C. within a period of less than 15 min, in particular about 10 min, to, in particular, at least 1.3 times, more particularly about 1.7 to 3 times, the complex viscosity at room temperature.

19. The method according to claim 10, wherein the adhesive in a manner known per se is applied by a printing process, in particular a screen-printing process.

20. (canceled)
